(19) United States
(12) Patent Application Publication
(10) Pub. No.: US 2013/0004738 A1
(43) Pub. Date: Jan. 3, 2013

(54) LOW CURL OR CURL FREE OPTICAL FILM-TO-PAPER LAMINATE

(75) Inventors: Gregory R. Jordan, Cumming, GA (US); Jonathan D. Gosnell, Atlanta, GA (US); Caroline B. Kennedy, Smyrna, GA (US)

(73) Assignee: VISUAL PHYSICS, LLC., Alpharetta, GA (US)

(21) Appl. No.: 13/491,171

(22) Filed: Jun. 7, 2012

Related U.S. Application Data
(60) Provisional application No. 61/501,993, filed on Jun. 28, 2011.

(51) Int. Cl. B32B 9/06; B32B 27/10; B32B 29/00; B32B 37/12; B32B 5/00; C08L 67/03; C08L 77/00; B32B 33/00; B32B 27/08

(52) U.S. Cl. 428/195.1; 428/220; 428/537.5; 428/480; 428/414; 428/511; 428/448; 428/513; 428/514; 525/419; 156/60

(57) ABSTRACT

An optical film material suitable for use in low curl or curl free optical film-to-paper laminates is provided. The inventive optical film material includes a light-transmitting polymeric optical spacer or carrier film that has a linear coefficient of thermal expansion (CTE) of less than about 25×10⁻⁶ mm/mm-° C. over the temperature range of from about 70 to about 160° C., or that is hygroscopic (e.g., has an ambient moisture absorption, measured as a percentage moisture content, similar to paper), or both. Also provided is an optical film-to-paper laminate (e.g., a micro-optic film-to-passport paper laminate) that demonstrates a reduction in (or elimination of) curl. The inventive laminate exhibits a maximum out-of-plane deformation of less than about 10%.

### RELATED APPLICATION

This application claims priority to U.S. Provisional Patent Application Ser. No. 61/501,993, filed Jun. 28, 2011, which is incorporated herein in its entirety by reference.

### TECHNICAL FIELD

The present invention generally relates to an optical film-to-paper laminate, and more particularly relates to a micro-optic film-to-security paper (e.g., passport paper) laminate that demonstrates a reduction in (or elimination of) curl.

### BACKGROUND AND SUMMARY OF THE INVENTION

By way of background, micro-optic films that present synthetic images have been sought after for use as thermal laminates for protecting passport paper data pages. Attempts to laminate standard micro-optic film materials in conjunction with thermally activated adhesives to data pages, however, have been problematic due to the strong propensity for the resulting structures to curl. In such cases, as the joined film material and paper cool, the edges begin to lift and curl toward the side having the film material.

Lengthy investigation into the causes of the curling behavior by the present inventors showed that neither the adhesive nor the cast micro-optic film components were contributing significantly to curl after lamination. It was discovered, however, that the optical spacer material (i.e., traditional biaxially oriented polyethylene terephthalate (PET)) within the micro-optic film material was largely responsible for the observed curling effect.

By replacing the optical spacer material with a film material that has a reduced linear dimensional change at the laminating temperatures specified below, or that is hygroscopic, or both, the net curl of the micro-optic laminate structure was greatly reduced or eliminated.

The present invention therefore provides an optical film material suitable for use in low curl or curl free optical film-to-paper laminates, the optical film material including a light-transmitting polymeric optical spacer or carrier film that has a linear coefficient of thermal expansion (CTE) of less than about 25×10⁻⁶ millimeters (mm)/mm-° C. over the temperature range of from about 70 to about 160° C., or that is hygroscopic (e.g., has an ambient moisture absorption, measured as a percentage moisture content, similar to paper), or both, the optical film material optionally exhibiting a pull strength of greater than about 7 Newtons (N) per centimeter (cm), preferably, greater than about 15 N/cm.

In one exemplary embodiment, the light-transmitting polymeric optical spacer or carrier film of the inventive optical film material has a linear coefficient of thermal expansion of less than about 25×10⁻⁶ mm/mm-° C. over the temperature range of from about 70 to about 160° C. and is prepared from biaxially oriented polyethylene napthalate (PEN). In another exemplary embodiment, the light-transmitting polymeric optical spacer or carrier film is hygroscopic and is prepared from biaxially oriented polyamide (BOPA) or nylon 6.

The present invention further provides a low curl or curl free optical film-to-paper laminate, which comprises the above-described optical film material laminated to a surface of a paper by means of one or more adhesives (e.g., heat-activatable and/or heat-sealable adhesives) located between the film material and the paper surface.

The term “low curl”, as used herein, is intended to mean a maximum out-of-plane deformation of less than about 10% (e.g., less than about 10 millimeters (mm) for a 10.2 cm by 10.2 cm sheet). The term “hygroscopic”, as used herein, is intended to mean a rate of water absorption of greater than 1 percent (1%) over a twenty-four (24) hour time period (ASTM D570). The term “pull strength”, as used herein, is intended to mean the strength required to pull apart the bonded surfaces of the optical film material (ASTM # D903-98, modified). ASTM # D903-98 was modified to the extent that: in Section 4 (of the apparatus) a hand crank was used instead of a power driven machine; and in Section 5 (test specimen) unconditioned samples measuring 25 mm by 75 mm were used instead of conditioned samples measuring 25 mm by 308 mm. Reported values were calculated as an average of the maximum strength values within the samples.

The optical film material of the present invention basically comprises (a) the light-transmitting polymeric optical spacer or carrier film described above, (b) one or more arrangements of image icons (e.g., micro-sized image icons) located on or within the polymeric film, and (c) one or more arrangements of focusing elements (e.g., microlenses). The image icon and focusing element arrangements are configured such that when the arrangement(s) of image icons is viewed through the arrangements(s) of focusing elements, one or more synthetic images are projected. These projected images may show a number of different optical effects.

As will be described in more detail below, to improve the adhesion of the arrangements of focusing elements and image icons to the polymeric optical spacer or carrier film, one or more adhesion primers may be applied to the carrier film prior to application of these arrangements to the film.

Light-transmitting polymeric optical spacers or carrier films that have a CTE of less than about 25×10⁻⁶ mm/mm-° C. over the temperature range of from about 70 to about 160° C., or that are hygroscopic, or both, are prepared from materials including, but are not limited to, PEN, BOPA or nylon 6, and combinations thereof. PEN films have a relatively low CTE of about 21.6×10⁻⁶ mm/mm-° C., while BOPA or nylon 6 films have the property of absorbing moisture with a resultant increase in dimensions similar to paper (e.g., security paper).

Contemplated papers for use in the inventive laminate may constitute cellulose-based papers, cotton papers, hybrid papers, linen papers, other types of security papers, and mixtures thereof, and may take the form of security papers such as passport papers, banknotes, identification cards, financial documents, entry passes, ownership certificates, visas, birth and death certificates, and any other security or identification-related paper document.

Heat-activatable or heat-sealable adhesives suitable for use in the inventive laminate have a heat-activation temperature of at least about 70 to about 160° C. Such adhesives include ethylene vinyl acetate, vinyl acetate ethylene, polyurethane, polyvinyl acetate, acrylates and methacrylates, polyethylene, silicones and epoxies, and copolymer mixtures thereof. These adhesives may contain crosslinking additives such as isocyanates, blocked isocyanates, aziridines, silanes, or other additives such as aromatic hydrocarbon tackifiers.

In an exemplary embodiment, the inventive laminate is a low curl or curl free micro-optic film-to-passport paper security laminate, which comprises:

a passport paper data page containing unique personal information for distinguishing a passport document from others; and

a micro-optic film material, which includes the above-described light-transmitting polymeric optical spacer or carrier film, laminated to a surface of the data page by means of one or more adhesives (e.g., heat-activatable or heat-sealable adhesives) located between the film material and the data page.

When laminated to a passport paper data page surface, the optical effects produced by the micro-optic film material serve to authenticate the passport document, while the micro-optic film material itself serves to protect the underlying data from tampering or manipulation.

The present invention also provides a method of manufacturing an optical film material suitable for use in a low curl or curl free optical film-to-paper laminate, the optical film material made up of one or more arrangements of focusing elements and one or more arrangements of image icons, the method comprising using a light-transmitting polymeric optical spacer or carrier film that has a CTE of less than about 25×10⁻⁶ mm/mm-° C. over the temperature range of from about 70 to about 160° C., or that is hygroscopic, or both, between the arrangements of focusing elements and image icons.

The present invention further provides a method of manufacturing a low curl or curl free optical film-to-paper laminate, the method comprising laminating an optical film material, which includes the above-described light-transmitting polymeric optical spacer or carrier film, to a surface of the paper using one or more adhesives (e.g., heat-activatable or heat-sealable adhesives).

The present invention also provides a method of reducing or eliminating curl in an optical film-to-paper laminate, the method comprising using the above-described light-transmitting polymeric optical spacer or carrier film between arrangements of focusing elements and image icons to make an optical film material, and then laminating the optical film material to a paper surface.

Other features and advantages of the invention will be apparent to one of ordinary skill from the following detailed description and accompanying drawings. Unless otherwise defined, all technical and scientific terms used herein have the same meaning as commonly understood by one of ordinary skill in the art to which this invention belongs. All publications, patent applications, patents and other references mentioned herein are incorporated by reference in their entirety. In case of conflict, the present specification, including definitions, will control. In addition, the materials, methods, and examples are illustrative only and not intended to be limiting.

### BRIEF DESCRIPTION OF THE DRAWINGS

The present disclosure may be better understood with reference to the following drawings. Matching reference numerals designate corresponding parts throughout the drawings, and components in the drawings are not necessarily to scale, emphasis instead being placed upon clearly illustrating the principles of the present disclosure. While exemplary embodiments are disclosed in connection with the drawings, there is no intent to limit the present disclosure to the embodiment or embodiments disclosed herein. On the contrary, the intent is to cover all alternatives, modifications and equivalents.

Particular features of the disclosed invention are illustrated by reference to the accompanying drawings in which:

FIG. 1 is a perspective view of a passport booklet;

FIG. 2 is a perspective view of a partially open passport booklet showing an exemplary embodiment of the inventive micro-optic film-to-passport paper data page security laminate on the inside front cover of the booklet; and

FIG. 3 is a cross-sectional view of the micro-optic film-to-passport paper data page security laminate shown in FIG. 2.

### DETAILED DESCRIPTION OF THE INVENTION

The optical film material of the present invention may be used as a thermal laminate for paper (e.g., passport paper data pages) without causing undesirable paper curl upon lamination. Moreover, suitability as a security laminate is increased when the inventive optical film material further exhibits improved pull strength.

It is noted that while the optical film material and laminate of the present invention is described herein mainly as a micro-optic film material used as a thermal laminate for passport paper data pages, it is not so limited. Macro-optic film materials and numerous paper types are also contemplated. By way of example, the subject invention may be considered for banknote applications, and in particular for surface-applied micro-optic film stripes or patches. As is known, microlens-based optical film materials are typically used in the form of very thin threads, strips, or ribbons that are partially embedded in, or mounted on a surface of, a security paper during paper manufacture. For wider, surface-applied optical film materials, curling has been observed once these film materials are in position on a surface of a banknote. The reduced curling feature offered by way of the subject invention allows for the application of wider stripes without curling in banknotes. By way of further example, the subject invention may also be considered for use with anti-counterfeiting labels for brand protection.

Referring now to the drawings in detail, a passport document utilizing an exemplary embodiment of the inventive micro-optic film-to-passport paper data page security laminate is depicted. The following description of the passport document and exemplary embodiment is not intended to be exhaustive or to limit the invention to the precise form depicted therein.

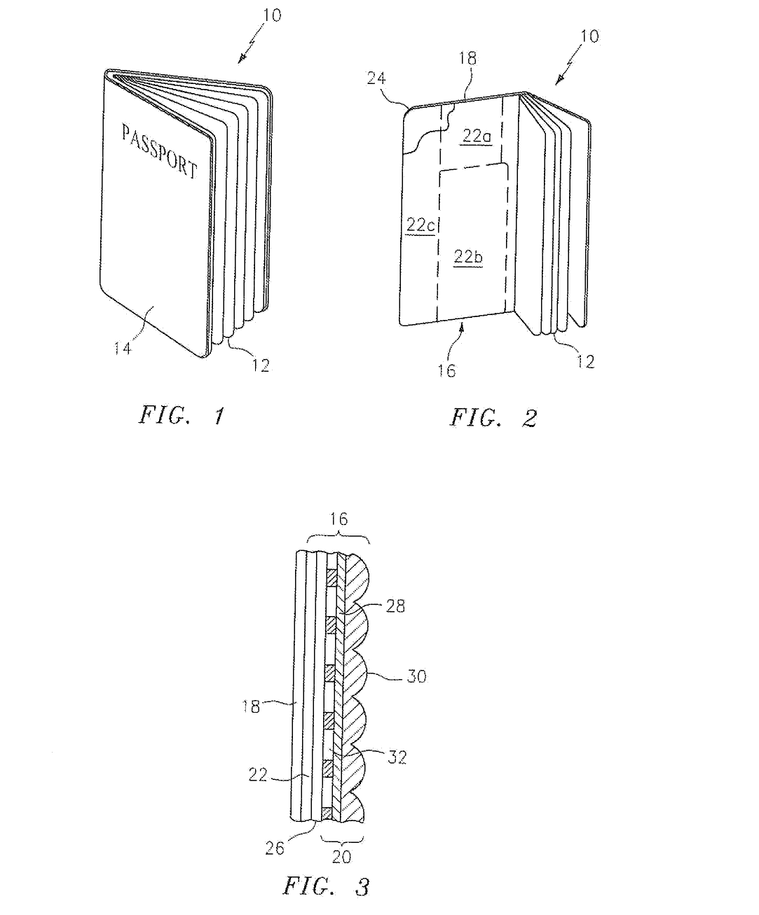

In FIG. 1, a typical passport booklet 10 is shown, the booklet made up of several pages of paper 12 bound within a durable cover such as vinyl 14. The subject invention is particularly concerned with machine readable passports (MRPs) that conform to the specifications promulgated by the International Civil Aviation Organization (ICAO). Such passports will be machine-readable and interoperable in all ICAO-compliant receiving States around the world.

When a passport is requested by an individual, the issuing office personalizes a standard ICAO compliant passport by entering the appropriate data, including a photographic image of the individual, specific identification data, and selected data that is machine readable, into a suitable computer/printer combined system. A passport paper data page, which is often the first paper page located within the inside front cover of each passport booklet, is then printed so that all of the desired information is imprinted on this page. Instead of a conventional transparent laminate sheet containing, for example, holograms, the micro-optic film material of the present invention (with applied adhesive (e.g., heat-activatable or heat-sealable adhesive)) is then laminated to the printed surface of the data page. In particular, the data page within the passport booklet having the inventive film material properly sized and positioned such that the adhesive bearing side faces the page is passed through a passport laminator which provides a suitable combination of heat, pressure and time to activate the heat-activatable or heat-sealable adhesive. When the passport booklet is removed from the laminator, the micro-optic film material is securely bonded in place on the data page. A similar process would also be used when personalizing a visa document.

FIG. 2 illustrates the passport booklet 10 of FIG. 1 opened to show an exemplary embodiment of the inventive micro-optic film-to-data page laminate 16 located on the first page of passport booklet 10 after opening the front cover 18 of the booklet. Micro-optic film material 20 is shown partially broken away from data page 22 in corner 24. The data page 22 contains a photographic zone 22a, a bearer data zone 22b, and a machine readable zone 22c.

The layered structure of laminate 16 located on front cover 18 of passport booklet 10 is shown in FIG. 3. Laminate 16 is made up of data page 22, heat-activated or het-sealable adhesive layer 26, and micro-optic film material 20, with micro-optic film material 20 being composed of a light-transmitting polymeric substrate 28, an array of microlenses 30, and an array of image icons 32. As noted above, when laminated to a passport data page surface, the optical effects produced by the micro-optic film material 20 serve to authenticate the passport booklet 10, while the micro-optic film material itself serves to protect the underlying data from tampering or manipulation.

The optical film material (e.g., micro-optic film material 20) of the present invention, which has a preferred thickness of less than about 60 microns (more preferably, from about 19 to about 35 microns), may be prepared in accordance with the teachings of U.S. Pat. No. 7,333,268 to Steenblik et al., U.S. Pat. No. 7,468,842 to Steenblik et al., U.S. Pat. No. 7,738,175 to Steenblik et al., and U.S. Patent Application Publication No. 2010/0308571 A1 to Steenblik et al., all of which are fully incorporated herein by reference as if fully set forth herein. As described in these references, arrays of focusing elements and image icons can be formed from a variety of materials such as substantially transparent or clear, colored or colorless polymers such as acrylics, acrylated polyesters, acrylated urethanes, epoxies, polycarbonates, polypropylenes, polyesters, urethanes, and the like, using a multiplicity of methods that are known in the art of micro-optic and microstructure replication, including extrusion (e.g., extrusion embossing, soft embossing), radiation cured casting, and injection molding, reaction injection molding, and reaction casting. High refractive index, colored or colorless materials having refractive indices (at 589 nm, 20° C.) of more than 1.5, 1.6, 1.7, or higher, such as those described in U.S. Patent Application Publication No. US 2010/0109317 A1 to Hoffmuller et al., may also be used in the practice of the present invention.

Other micro-optic film material constructions and methods of fabrication may be found in U.S. Pat. No. 7,830,627 to Commander et al., U.S. Pat. No. 8,149,511 to Kaule et al.; U.S. Patent Application Publication No. 2010/0177094 to Kaule et al.; U.S. Patent Application Publication No. 2010/0182221 to Kaule et al.; European Patent No. 2162294 to Kaule et al.; and European Patent Application No. 08759342.2 (or European Publication No. 2164713) to Kaule.

An exemplary method of manufacture for the inventive optical film material is to form the image icons as voids in a radiation cured liquid polymer (e.g., acrylated urethane) that is cast against the polymeric substrate or optical spacer (e.g., PEN), then to form the focusing elements as lenses from the radiation cured polymer on the opposite face of the polymeric substrate in correct alignment or skew with respect to the image icons, then to fill the icon voids with a submicron particle pigmented coloring material by gravure-like doctor blading against the film surface, and solidify the fill by suitable means (e.g., solvent removal, radiation curing, or chemical reaction).

Polymeric substrates or optical spacers (e.g., light-transmitting polymeric substrate 28) that exhibit the necessary CTE over the laminating temperature range, or that are hygroscopic, or both, have been previously described as prepared from materials including, but are not limited to, polyamides such as BOPA or nylon 6, PEN, and combinations thereof.

To improve the adhesion (i.e., bond or pull strength) of the arrangements of focusing elements and image icons to the polymeric substrate or optical spacer in the inventive optical film materials, one or more adhesion primers may be applied to the polymeric substrate prior to application of these arrangements to the substrate. When, for example, polyamides (e.g., BOPA or nylon 6) or PEN are used as the light-transmitting polymeric substrate, the following primers have been found to increase the adhesion or bond strength of the focusing element and image icon arrangements to the polymeric substrate: a polyurethane dispersion (35% solids), available from H.B. Fuller Company, 1200 Willow Lake Boulevard, P.O. Box 64683, St. Paul, Minn. 55164-0683 (“H.B. Fuller”), under the product designations WD4047 adhesion primer, a polyurethane dispersion (35% solids) combined with a blocked isocyanate, available from Baxenden Chemicals Limited, Worsley Street, Rising Bridge, Accrington BB5 2SL, United Kingdom, and a polyurethane adhesion primer obtained from Crown Roll Leaf, Inc., 91 Illinois Avenue, Paterson, N.J. 07503 USA (“Crown Roll Leaf”).

The optical film material of the present invention may comprise additional features, such as those described in U.S. Pat. No. 7,333,268 to Steenblik et al., U.S. Pat. No. 7,468,842 to Steenblik et al., U.S. Pat. No. 7,738,175 to Steenblik et al., and U.S. Patent Application Publication No. 2007/0273143 to Crane et al. By way of example, enhanced optically variable effects may be formed by combining or registering the synthetically magnified images generated by the optical film material with the static 2D images on the passport paper data page. In addition, after a heat-activatable or heat-sealable adhesive has been applied to the image icon side of the optical film material, data may be printed directly on the adhesive prior to lamination, thereby providing another means for authenticating the paper document.

The inventive optical film material is laminated to paper using conventional lamination techniques, for example, by applying an adhesive to the image icon side of the optical film material, positioning the adhesive bearing side of the film material on the paper, and then applying pressure to the layered structure for a time and at a temperature sufficient to activate the adhesive to form a secure bond. The resulting laminate has a preferred thickness of less than about 1000 microns, more preferably from about 50 to about 500 microns, most preferably, from about 150 to about 250 microns.

For papers such as banknotes, the optical film material may take the form of a stripe or patch, covering from about 1 to about 16% of the total surface area of one side of the banknote. For papers such as passport papers or identification cards, the optical film material may cover all or a portion of the total surface area, for example, greater than about 16 to about 100% of the total surface area of one side of the paper or card.

Aspects of the present invention will now be further illustrated by reference to the following non-limiting working examples.

### EXAMPLES

Micro-optic film samples having a thickness of 25.4 microns, 50.8 microns, or 76.2 microns were fabricated using the same method and constituent materials except for the polymeric substrate or optical spacer material, which as shown in Table 1 below, was different for each sample at a given thickness to measure contribution to curl in the final laminate.

The fabricated micro-optic film samples were cut to approximately 10.2 cm by 10.2 cm, and then a combination of polyurethane-based adhesives were applied to the image icon side of each cut film sample. In a first application, a five (5) micron thick layer of a polyurethane dispersion (35% solids) obtained from H.B. Fuller under the product designation WD4047 adhesion primer, was applied and the sample dried in an oven at a temperature of 38° C. (100° F.) for two (2) minutes. In a second application, a five (5) micron thick layer of a polyurethane adhesion primer obtained from Crown Roll Leaf, was applied and the sample again dried in an oven at a temperature of 38° C. (100° F.) for two (2) minutes. Each resulting sample was then placed against a sample sheet of passport paper and then placed inside a sample passport booklet for lamination. The sample booklet was then passed through a passport laminator (i.e., Model 5000T Wide Pouch Laminator, TLC Thermal Laminating Corporation, Evanston, Ill. 60202) and laminated at a temperature of 135° C. (275° F.). Each sample booklet was allowed to cool for several minutes with approximately 1.4 kilograms of weight being applied to the booklet, and the test sample sheet was then removed from the booklet.

The curl of each laminated test sample was then measured by placing the sample on a flat surface, and then taking the average of the height at the midpoint of two curled edges. The results are shown in Table 1 below.

TABLE 1

| Film Thickness | | |
|---|---|---|
| (microns) | Film Type | Curl (mm) |
| 25.4 | polyethylene terephthalate | 12.10 |
| 25.4 | nylon 6 | 2.84 |
| 25.4 | polyethylene naphthalate | 2.79 |
| 25.4 | polyether ether ketone | 8.18 |
| 25.4 | ethylene chlorotrifluoroethylene | 28.02 |
| 50.8 | polyethylene terephthalate | 11.84 |
| 50.8 | polycarbonate | 26.2 |
| 50.8 | polyphenylsulfone | 12.72 |
| 50.8 | polyethersulfone | 11.55 |
| 76.2 | polysulfone | 8.6 |

As is readily evident from the results shown in Table 1, micro-optic film-to-passport paper laminates in which either nylon 6 or PEN is used as the polymeric substrate or optical spacer in the micro-optic film material demonstrated a marked reduction in curl.

While various embodiments of the present invention have been described above, it should be understood that they have been presented by way of example only, and not limitation. Thus, the breadth and scope of the present invention should not be limited by any of the exemplary embodiments.

What is claimed is:

1. An optical film material suitable for use in low curl or curl free optical film-to-paper laminates, the optical film material including a light-transmitting polymeric optical spacer or carrier film that has a linear coefficient of thermal expansion of less than about 25×10⁻⁶ mm/mm-° C. over the temperature range of from about 70 to about 160° C., or that is hygroscopic, or both, the optical film material optionally exhibiting a pull strength of greater than about 7 Newtons per centimeter.

2. The optical film material of claim 1, wherein the light-transmitting polymeric optical spacer or carrier film has a linear coefficient of thermal expansion of less than about 25×10⁻⁶ mm/mm-° C. over the temperature range of from about 70 to about 160° C. and is prepared from biaxially oriented polyethylene napthalate.

3. The optical film material of claim 1, wherein the light-transmitting polymeric optical spacer or carrier film is hygroscopic, and is prepared from biaxially oriented polyamide.

4. The optical film material of claim 1, wherein the light-transmitting polymeric optical spacer or carrier film has an ambient moisture absorption, measured as a percentage moisture content, similar to paper.

5. The optical film material of claim 1, which comprises (a) the light-transmitting polymeric optical spacer or carrier film, (b) one or more arrangements of image icons located on or within the polymeric film, and (c) one or more arrangements of focusing elements, wherein the image icon and focusing element arrangements are configured such that when the one or more arrangements of image icons is viewed through the one or more arrangements of focusing elements, one or more synthetic images are projected.

6. The optical film material of claim 5, wherein one or more adhesion primers are applied to the polymeric film prior to application of the one or more arrangements of image icons and the one or more arrangements of focusing elements to the film.

7. The optical film material of claim 6, wherein the polymeric film is prepared from a material selected from the group of polyethylene napthalate, biaxially oriented polyamide, and combinations thereof, and wherein the one or more adhesion primers is a polyurethane dispersion optionally combined with a blocked isocyanate.

8. The optical film material of claim 1, which has a thickness of less than about 60 microns.

9. The optical film material of claim 8, which has a thickness ranging from about 19 to about 35 microns.

10. A low curl or curl free optical film-to-paper laminate, which comprises an optical film material laminated to a surface of a paper by means of one or more adhesives located between the film material and the paper surface, wherein the optical film-to-paper laminate exhibits a maximum out-of-plane deformation of less than about 10%.

11. A low curl or curl free optical film-to-paper laminate, which comprises an optical film material laminated to a surface of a paper by means of one or more adhesives located between the film material and the paper surface, wherein the optical film material includes a light-transmitting polymeric optical spacer or carrier film that has a linear coefficient of thermal expansion of less than about 25×10⁻⁶ mm/mm-° C. over the temperature range of from about 70 to about 160° C., or that is hygroscopic, or both, the optical film material optionally exhibiting a pull strength of greater than about 7 Newtons per centimeter.

12. The low curl or curl free optical film-to-paper laminate of claim 11, wherein the light-transmitting polymeric optical spacer or carrier film of the optical film material has a linear coefficient of thermal expansion of less than about 25×10⁻⁶ mm/mm-° C. over the temperature range of from about 70 to about 160° C. and is prepared from biaxially oriented polyethylene napthalate.

13. The low curl or curl free optical film-to-paper laminate of claim 11, wherein the light-transmitting polymeric optical spacer or carrier film of the optical film material is hygroscopic, and is prepared from biaxially oriented polyamide.

14. The low curl or curl free optical film-to-paper laminate of claim 11, wherein the light-transmitting polymeric optical spacer or carrier film of the optical film material has an ambient moisture absorption, measured as a percentage moisture content, similar to paper.

15. The low curl or curl free optical film-to-paper laminate of claim 11, wherein the one or more adhesives located between the film material and the paper surface is selected from the group of heat-activatable adhesives, heat-sealable adhesives, and combinations thereof.

16. The low curl or curl free optical film-to-paper laminate of claim 15, wherein the one or more adhesives have a heat-activation temperature of at least about 70 to about 160° C.

17. The low curl or curl free optical film-to-paper laminate of claim 16, wherein the one or more adhesives are selected from the group of ethylene vinyl acetate, vinyl acetate ethylene, polyurethane, polyvinyl acetate, acrylates and methacrylates, polyethylene, silicones and epoxies, and copolymer mixtures thereof, and optionally further contain one or more additives selected from the group of crosslinking additives, tackifiers, and combinations thereof.

18. The low curl or curl free optical film-to-paper laminate of claim 11, wherein the paper is a security or identification-related paper document with two opposing sides, each side having a total surface area.

19. The low curl or curl free optical film-to-paper laminate of claim 18, wherein the optical film material is in the form of either a stripe or patch, which covers from about 1 to about 16% of the total surface area of one side of the paper document.

20. The low curl or curl free optical film-to-paper laminate of claim 19, wherein the security or identification-related paper document is a banknote.

21. The low curl or curl free optical film-to-paper laminate of claim 18 wherein the optical film material covers greater than about 16 to about 100% of the total surface area of one side of the paper document.

22. The low curl or curl free optical film-to-paper laminate of claim 21, wherein the security or identification-related paper document is a passport paper or identification card.

23. A low curl or curl free micro-optic film-to-passport paper security laminate, which comprises:
a passport paper data page containing unique personal information for distinguishing a passport document from others; and
a micro-optic film material laminated to a surface of the data page by means of one or more adhesives located between the film material and the data page, the micro-optic film material including a light-transmitting polymeric optical spacer or carrier film that has a linear coefficient of thermal expansion of less than about 25×10⁻⁶ mm/mm-° C. over the temperature range of from about 70 to about 160° C., or that is hygroscopic, or both, the micro-optic film material optionally exhibiting a pull strength of greater than about 7 Newtons per centimeter.

24. The low curl or curl free micro-optic film-to-passport paper security laminate of claim 23, wherein the micro-optic film material comprises (a) the light-transmitting polymeric optical spacer or carrier film, (b) one or more arrangements of image icons located on or within the polymeric film, and (c) one or more arrangements of focusing elements, wherein the image icon and focusing element arrangements are configured such that when the one or more arrangements of image icons is viewed through the one or more arrangements of focusing elements, one or more synthetic images are projected.

25. The low curl or curl free micro-optic film-to-passport paper security laminate of claim 24, wherein the one or more synthetic images are combined or registered with static two-dimensional images on the passport paper data page.

26. The low curl or curl free micro-optic film-to-passport paper security laminate of claim 23, wherein printed data is located on a layer formed by the one or more adhesives, the printed data located between the adhesive layer and the data page, thereby providing another means for authenticating the laminate.

27. The low curl or curl free micro-optic film-to-passport paper security laminate of claim 23, which has a thickness of less than about 1000 microns.

28. The low curl or curl free micro-optic film-to-passport paper security laminate of claim 27, which has a thickness ranging from about 50 to about 500 microns.

29. The low curl or curl free micro-optic film-to-passport paper security laminate of claim 28, which has a thickness ranging from about 150 to about 250 microns.

30. A method of manufacturing an optical film material suitable for use in a low curl or curl free optical film-to-paper laminate, the optical film material made up of one or more arrangements of focusing elements and one or more arrangements of image icons, the method comprising using a light-transmitting polymeric optical spacer or carrier film that has a linear coefficient of thermal expansion of less than about 25×10⁻⁶ mm/mm-° C. over the temperature range of from about 70 to about 160° C., or that is hygroscopic, or both, between the arrangements of focusing elements and image icons.

31. The method of claim 30, wherein the optical film material further comprises one or more adhesion primer layers between the light-transmitting polymeric optical spacer or carrier film and the arrangements of focusing elements and image icons.

32. The method of claim 31, wherein the light-transmitting polymeric optical spacer or carrier film is prepared from a material selected from the group of polyethylene napthalate, biaxially oriented polyamide, and combinations thereof, and wherein the one or more adhesion primer layers is prepared from a polyurethane dispersion optionally combined with a blocked isocyanate.

33. A method of manufacturing a low curl or curl free optical film-to-paper laminate, the method comprising laminating an optical film material to a surface of the paper using one or more adhesives, wherein the optical film material includes a light-transmitting polymeric optical spacer or carrier film that has a linear coefficient of thermal expansion of less than about 25×10⁻⁶ mm/mm-° C. over the temperature range of from about 70 to about 160° C., or that is hygroscopic, or both, the optical film material optionally exhibiting a pull strength of greater than about 7 Newtons per centimeter.

34. A method of reducing or eliminating curl in an optical film-to-paper laminate, the method comprising using a light-transmitting polymeric optical spacer or carrier film that has a linear coefficient of thermal expansion of less than about 25×10⁻⁶ mm/mm-° C. over the temperature range of from about 70 to about 160° C., or that is hygroscopic, or both, between arrangements of focusing elements and image icons to make an optical film material, and then laminating the optical film material to a paper surface.

35. The method of claim 34, wherein the optical film material further comprises one or more adhesion primer layers between the light-transmitting polymeric optical spacer or carrier film and the arrangements of focusing elements and image icons.

36. The method of claim 35, wherein the light-transmitting polymeric optical spacer or carrier film is prepared from a material selected from the group of polyethylene napthalate, biaxially oriented polyamide, and combinations thereof, and wherein the one or more adhesion primer layers is prepared from a polyurethane dispersion optionally combined with a blocked isocyanate.
